(19) United States
(12) Patent Application Publication
(10) Pub. No.: US 2008/0245593 A1
(43) Pub. Date: Oct. 9, 2008

(54) Hybrid light electric vehicle with all-wheel power train

(76) Inventor: Richard J. Kim, Great Falls, VA (US)

Correspondence Address: RICHARD J. KIM, 1004 SPRINGVALE RD, GREAT FALLS, VA, 22066, US

(21) Appl. No.: 11/730,597

(22) Filed: Apr. 3, 2007

(51) Int. Cl. B60K 6/00; B62D 61/08

(52) U.S. Cl. 180/212; 180/65.2

(57) ABSTRACT

The disclosure relates to automotive technology, particularly relating to an all-wheel power train adaptable to a three-wheeled land vehicle. A hybrid light electric vehicle having three wheels is disclosed, comprising three wheels suspended from a land vehicle chassis; three electric motors, each of the electric motors drivingly coupled to the respective one of the three wheels; at least one rechargeable battery; a vehicle-mounted combustion-engine electric generator; and hybrid control means. A fighting military vehicle is disclosed based such a hybrid light electric vehicle.

### FIELD

The disclosure relates to light electric vehicles, particularly relating to three-wheeled light electric vehicles.

### BACKGROUND

Hybrid vehicles are known. For example, various land vehicles, ranging from sedans, SUVs, and other four-wheeled automobiles now enjoy the hybrid technology. However, experiments that lead up to modern-day hybrid technology can trace back to as far as World War II, when during the war, the military investigated alternative propulsion means for its military vehicles. Little known folklores range from diesel-powered German motorcycles to bio-fueled military transport vehicles, etc. Among the variety of early ideas, many have survived and continue to make their presence with varying degrees of success. In one example, a plastic container in the trunk of a diesel car is used to hold vegetable oil as a switchable source of bio-fuel.

There are commercially marketed hybrid pedaled vehicles. Some of the most successfully marketed to date are called light electric vehicles. Other variants that appear to remain in infancy stages have their presence felt particularly in Southeast Asia, such as the motor assisted pedal rickshaw (MAPRA). In general, light electric vehicles refer to a three-wheeled vehicle that is based on electric power. This can be thought of as a modern-day adaptation of an old-fashioned rickshaw.

Most commonly, three-wheeled cycle rickshaws, in their pedal-powered version, make their presence in various tourist attractions and commercial areas as pedicabs, velotaxis™ or trishaws. Typically, hybrid advancements adapt an electric motor to augment an existing rear-wheel pedaled arrangement such that either the pedal or the electric motor can power the rear wheels.

All-wheel drive is becoming popular in the automotive market. All-wheel drive vehicles distinguish themselves from four-wheel drive vehicles in that they typically don't standout as jeeps or all-terrain vehicles (ATV). In fact, many popular models come as regular sedan, or more realistically, luxury sedans. Accordingly, an all-wheel drive vehicle is popularly viewed as a luxury sedan adaptation of some of the best features of a jeep. However, Applicant's concept of an all-wheel drive for a three-wheeled vehicle is unknown to date, thus, not even in the vocabulary in today's societies.

In one aspect, all wheels can be driven for an all-wheel drive vehicle. But to date this concept extends to four-wheeled vehicles. All-wheel drive's predecessor, the four-wheel drive can be found in commercial, personal and military vehicles. For example, HMMWV (High-Mobility Multipurpose Wheeled Vehicle) is a light, highly mobile, diesel-powered, four-wheel-drive vehicle. Its predecessor is the famous ¼-ton 4×4 truck called the jeep. Today, we have four-wheel drive jeeps, ATVs, trucks, including the popular, all-wheel drive sedans and SUVs. Nevertheless, today's vehicles are powered either by one singular propulsion means, or are driven from one single transmission.

According to the state-of-the-art, the very nature of the complex drive train being linked to one singular transmission source has it's own hidden weaknesses. All of today's power train is based on a singular focal distribution of automotive power concentrated from one identifiable transmission. Further, an all-wheel drive tends to be a limited, stopgap measure to address the spin out under slippery conditions. For a four-wheel drive vehicle, once a wheel starts free spinning, the rest of the driven wheels loose power. This is the very nature of a four-wheel drive technology as it exists today. All-wheel drive tends to balance this by automatically redistributing the torque when a wheel starts to spin.

Another hidden weakness is that, in a military context, a single point of failure can bring the whole vehicle to a grinding halt: For example, four-wheel drive vehicles have a single transmission powering their complex drive train. With known drive trains, there is a single point of failure at the origination point of the drive train that can bring a military wheeled vehicle to a halt. Accordingly, the known drive trains are all based upon a single point of transmission to drive the complex drive train.

Today's military vehicles must constantly evolve, or become vulnerable to ever-sophisticated improvised explosive devices (IEDs). HMMWV, initially configured with no armor protection now must be retrofitted with blast protection. In summary, today's military fighting vehicles remain vulnerable to: Single points of failure, frontal and side IED detonations, mine detonations, fuel supply, vehicular infra-red (IR) emissions, and ground radar detection. Applicant believes there is an elegant solution that can have a tremendous impact in these issue areas. Some of the issues addressed overlap into the commercial and personal transport arenas, where performance, reliability, efficiency, safety and assured drivability are common underlying requirements. It's time for a real alternative that is intelligently configured and workable for assured drivability that is light, agile and capable of being stealthy.

### SUMMARY

Applicant has sought to solve the problem of the inability of the automotive market to intelligently integrate all of the desirable features in today's commercial transportation, personal transportation, and safe fighting military vehicle.

Applicant has disclosed an all-wheel power train adaptable to a three-wheeled land vehicle, e.g., a hybrid light electric vehicle, each of the three wheels capable of being driven by a dedicated electric motor.

Applicant has disclosed a hybrid light electric vehicle having three wheels, each wheel capable of being driven by a dedicated electric motor. The electric motor is energized from a rechargeable battery. The battery can be either charged or recharged by or from a plurality of the following means: an external DC power source, an external AC power source, an internal vehicle-mounted combustion-engine generator, and/or a vehicle mounted solar or thermal energy converter.

Applicant has disclosed a fighting military vehicle based on a hybrid light electric vehicle having three wheels, each wheel capable of being driven by a dedicated electric motor. The three-wheel configuration defines a pseudo-triangular chassis structure. The outer skin of the vehicle is contoured based on the triangular geometric shape formed by the three wheels. The geometric triangle is used to configure a sloping stealthy body skin made of blast-resistant materials, e.g., various combination of Kevlar™ blast protection at key extremities and bullet-proof glass at key deflection surfaces around a steel cage to deflect and withstand frontal and side radar emissions and/or IED blasts.

Applicant believes these smart solutions in vehicle technology can provide the essential answers to the issues being faced in the military, commercial and personal transportation arenas.

### BRIEF DESCRIPTION OF THE DRAWINGS

The exemplary hybrid light electric vehicles with all-wheel power train are variously illustrated in the following figures:

FIG. 1 shows an exemplary all-wheel power train adaptable to a three-wheeled land vehicle, e.g., a hybrid light electric vehicle, each of the three wheels capable of being driven by a dedicated electric motor;

FIG. 2 shows an exemplary hybrid light electric vehicle having three wheels, each wheel capable of being driven by a dedicated electric motor; and

FIG. 3a shows an exemplary top view of a contouring of blast protection surface, with exemplary sloping of the sides of a triangular shaped vehicle, characterized by a contoured rise from the extremities to the center compartment; and

FIG. 3b shows an exemplary side view of a contouring of blast protection surface, with exemplary sloping of the sides of a triangular shaped vehicle, characterized by a contoured rise from the extremities to the center compartment.

### DETAILED DESCRIPTION

A consumer's need for the advantages of an all-wheel drive vehicle for an all-weather assured drivability without the typical disadvantages of an all-wheel drive vehicle is not truly met. In another aspect, today's military's vulnerability to single points of failure, inadequate IED protection, dependence on a single fuel type with a fixed fuel-tank capacity, vehicular IR emissions and ground radar exposure must be expediently solved.

In another aspect of the disclosure, a fighting military vehicle is disclosed based on a hybrid light electric vehicle having three wheels, each wheel capable of being driven by a dedicated electric motor. By contouring the blast protection surface, e.g., by sloping the sides of a triangular vehicle to have a contoured rise from the extremities to the center compartment, the shape becomes like a triangular flying saucer, or a contoured version of a stealth fighter plane, thereby denying a significant direct penetrable impact area.

In a non-regenerative electric drive mode, the vehicle is also expected to be stealthy, being silent and/or IR emission-free. By having the frontal and side dimensions contoured and sloping, analogous to a stealth fighter, Applicant also believes the skin configuration can also be evasive against fixed ground radar, even in a mass formation.

Applicant believes these smart solutions in vehicle technology can provide the essential answers to the issues being faced in the military, commercial and personal transportation arenas.

### Distributed Drive Train

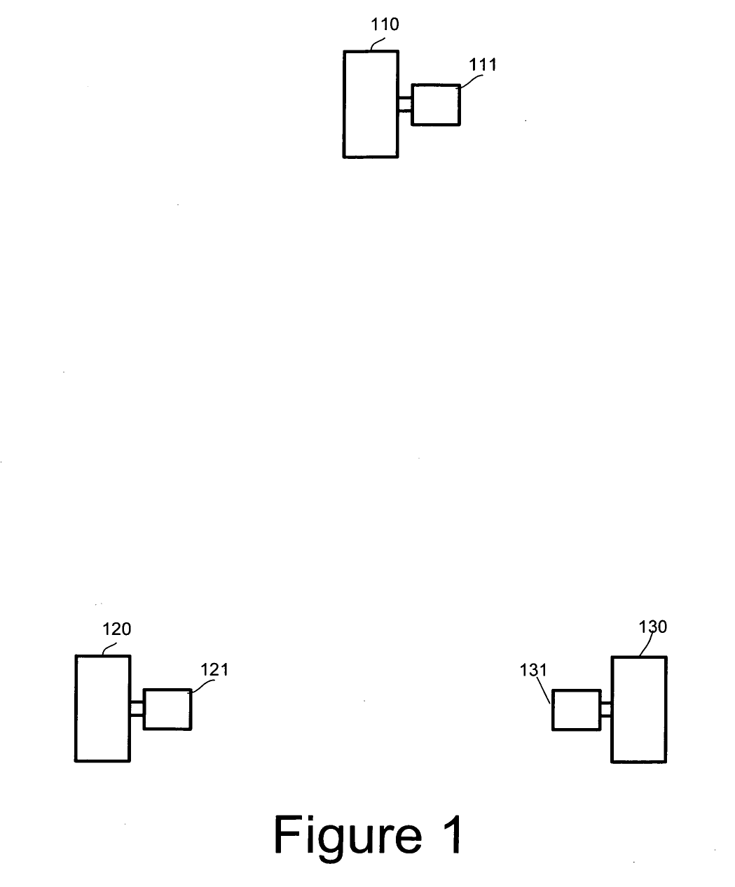

Applicant has disclosed an all-wheel power train adaptable to a three-wheeled land vehicle. The total solution lies in a decoupled, distributed drive train using a dedicated electric motor drive per wheel. For example, FIG. 1 shows an exemplary distributed drive train for a hybrid light electric vehicle 100, each of the three wheels (110, 120 and 130) capable of being driven by a dedicated electric motor (111, 121 and 131).

As is known for three-wheeled land vehicle, the front wheel 110 can be steered. However, alternatively, because the drive train is distributed, each wheel capable of being independently driven, it is possible to have an all-wheel (110, 120 and 130) steering capability.

Applicant has disclosed a hybrid light electric vehicle having three wheels, each wheel capable of being driven by a dedicated electric motor. The electric motors (111, 121 and 131) are energized from a rechargeable battery 140. The battery can be either charged or recharged by or from at least one of the following means: an external DC power source, an external AC power source, an internal vehicle-mounted combustion-engine generator, and/or an auxiliary solar or thermal energy converter which can be either vehicle mounted or portable. As necessary, a known converter can be used as an interface to the motor.

In one exemplary embodiment, the vehicle 100 utilizes a known electric generator in that a combustion engine 151, e.g., a gasoline engine, ethanol engine, a diesel engine, or a bio-diesel engine, can drive an electric generator 150 to charge or recharge the battery 140.

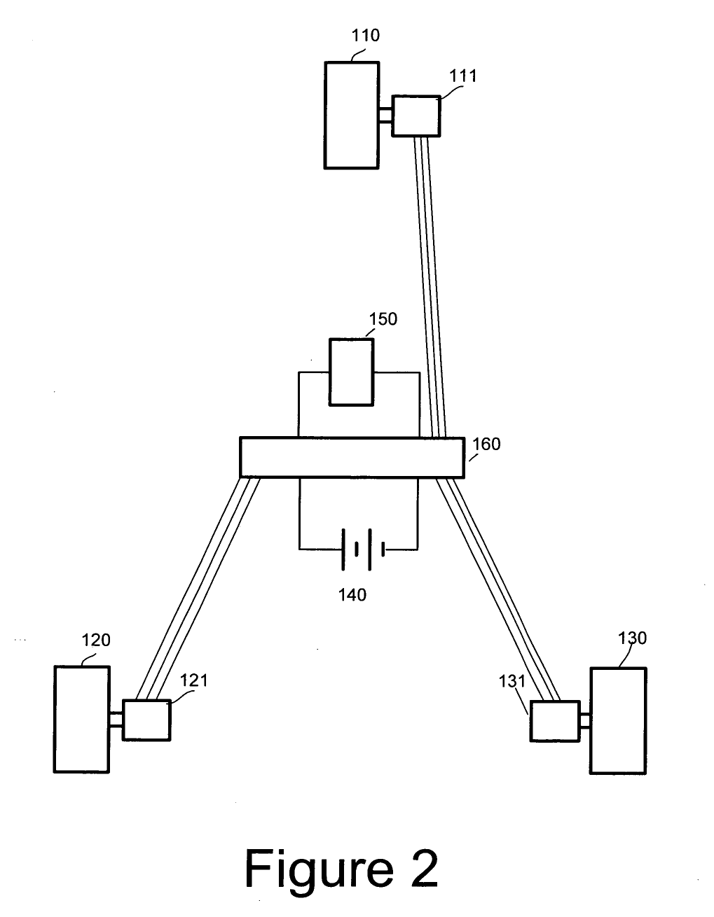

As exemplified in FIG. 2, the disclosure teaches decoupled, independently operated propulsion means that are centrally controlled to coordinate the propulsion. A single electric motor (111, 121 or 131), e.g., any known A.C. or D.C. electric motor for driving a hybrid vehicle, separately powers the wheel it is coupled to. A motor (111, 121 or 131) is energized by a known rechargeable battery 140, and is controlled by a controller 160 to power the motor (111, 121 or 131).

Each motor drive is mechanically decoupled. One mechanically works independently of another. There is therefore a triple redundancy in direct power drive of such a hybrid light electric vehicle having three wheels. It is an all-wheel drive vehicle that does not have a single mechanical point of failure. In the worst-case scenario, one motor that is drivingly coupled to one wheel can propel the entire vehicle, as long as the vehicle is able to roll on its wheels. Further, the electric motors (111, 121 or 131) do not need to be of a typical power rating for a commercially marketed four-wheel drive. The multiple propulsion means (111, 121 and 131) can definitely complement each other to boost performance. Accordingly, the motors (111, 121 and 131) need not be rated to the fill vehicle performance rating, because the overall vehicle performance is in essence the sum of the performances yielded by the independent propulsion means that are available. Accordingly, this is true performance and efficiency with streamlined configuration.

### Motor Mount

In one exemplary embodiment, propulsion means, such as an electric motor (111, 121 or 131), can be fixed to a chassis, and can utilize known jointed links, e.g., the propulsion means driving a jointed shaft which drives a suspended wheel (110, 120 or 130). This is encompassed by Applicant's disclosure.

Alternatively, a drive motor (111, 121 and 131) itself can be compact, and in an alternate embodiment, the individual electric motor (111, 121 or 131) can be removed from the chassis itself, e.g., nestled in a suspension mechanism to drive the associated wheel (110, 120 or 130), or is integral to the wheel mechanism itself. For example, a compact electric motor (111, 121 or 131) can be formed integral with a disc assembly of a disc brake, nestled in a suspension arrangement, or even hidden within a wheel well of the associated wheel (110, 120 or 130). These alternate exemplary arrangements are also encompassed by the Applicant's disclosure.

For an exemplary decoupled power-train arrangement as disclosed, the electric power does not need to provide the level of torque matching the capacity of the combustion engine. Any significant capacity to provide torque from an electric motor in an intelligently controlled manner can in reality meet the all-weather needs of a vehicle user. The independently driven wheels (110, 120 and 130) do not need to prove equal torque under all circumstances, and under such a distributed and decoupled electric-powered drive arrangement, such a hybrid vehicle can in totally provide the requisite power, performance and the agility of an all-wheel drive as a three-wheeled land vehicle.

This unique arrangement can have its own advantages. First, all manners of components, including the electric motor (111, 121 or 131), the electric battery 140 and the drive train, can be deliberately designed to be unusually underrated compared to a full-blown hybrid vehicle. This is good for achieving the overall performance-efficiency-cost goal. Any such simplification can lead to reliability, superior performance, agility, and translate to simple cost savings.

### Power Generation

In the context of hybrid technology, the electric motor (111, 121 or 131) can in itself serve as the electric regeneration plant. That is, an electric motor (111, 121 or 131) that is used for a hybrid vehicle can also serve as an electric generator 150. This is a known technology, and is within the scope of the present disclosure. For example, the wheel (110, 120 or 130) that is powered by the respective electric motor (111, 121 or 131) can also at times generate electricity. This concept is known in the industry as power regeneration, e.g., during braking or coasting. This concept is also within the scope of the present disclosure.

Alternatively, power can be generated from a traditional generator arrangement 150 that is driven by any one of a gasoline, ethanol, diesel, or bio-diesel combustion engine 151. This concept is also within the scope of the present disclosure.

### Hybrid Control

Hybrid control as a singular concept is known. However, Applicant has realized a unique requirement to control a hybrid of up to three decoupled drive trains powered independently. Accordingly, the hybrid control (e.g., 160) for an exemplary decoupled all-wheel drive configuration (e.g., FIG. 2) based on a hybrid light electric vehicle having three wheels is in itself novel.

One exemplary hybrid control (e.g., 160) can take advantage of a pure hybrid accelerator interface. By this, an accelerator pedal can have the look and feel of an accelerator pedal, but has no mechanical linkage to the respective power plant. That is, the accelerator depression is translated into electric signals to an electric control to drive the respectively motor(s) (111, 121 and/or 131). This is Applicant's unique adaptation of known control concept for the purpose of coordinated control of a plurality of drive means, and is encompassed by Applicant's present disclosure.

As a further exemplary hybrid electronic control (e.g., 160), an electronic control can control both the at least one electric motor (111, 121 or 131) and the combustion-engine generator (150) based upon a combination of an accelerator depression and dashboard control settings. For example, the dashboard control can set operating conditions e.g., whether the vehicle is set for a stealth-drive mode with the generator 150 capability disabled, maximum-power mode with the generator 150 fully powered and engaged, two-wheel drive mode, all-wheel drive mode, or even a one-wheel drive mode. These and other exemplary embodiments are all encompassed by the present disclosure

Another exemplary embodiment can employ mechanical linkages from the accelerator to a throttling mechanism of a combustion engine generator and/or a hybrid control (e.g., 160). This exemplary embodiment is encompassed by the present disclosure.

Yet another exemplary hybrid control (e.g., 160) is a combination of mechanical linkages and electronic control. For example, an accelerator depression can result in movement of the throttle of a combustion-engine generator, while at the same time, providing control input to an electronic control to the at least one electric motor.

### Stealth and Blast Protection

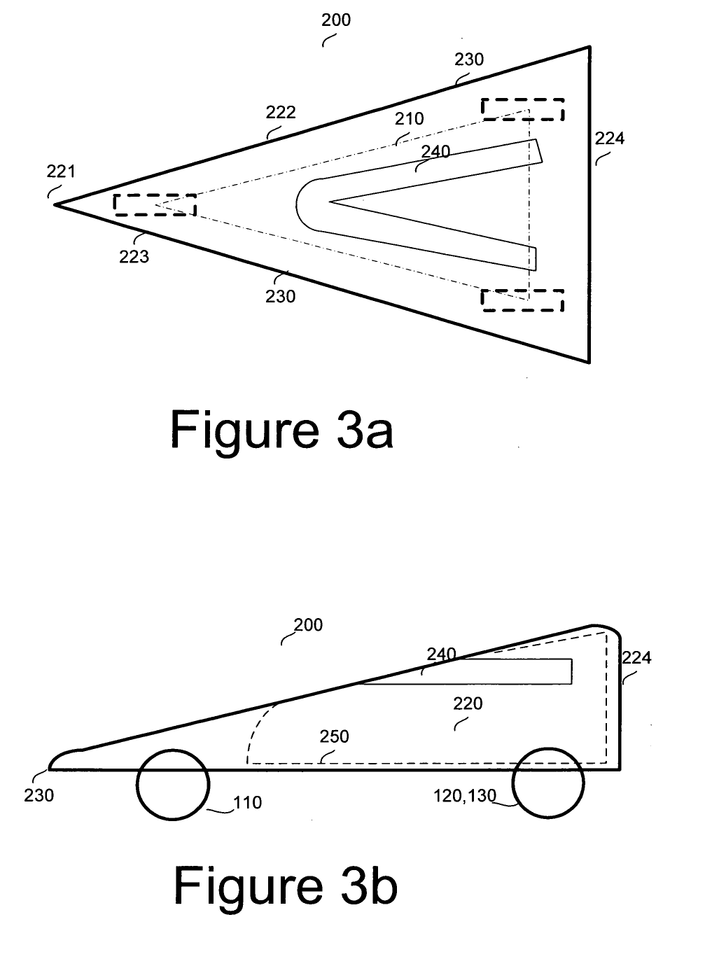

As exemplified in FIGS. 3a and 3b, a fighting military vehicle 200 is disclosed based on a hybrid light electric vehicle 100 having three wheels (110, 120 and 130), each wheel (110, 120 or 130) being capable of being driven by a dedicated electric motor (111, 121 or 123). The three-wheel configuration defines a pseudo-triangular chassis structure 210. The outer skin 220 of the vehicle 200 is contoured based on the triangular geometric shape formed by the three wheels (110, 120 and 130). The geometric triangle is used to configure a sloping stealthy body skin 220 made of blast-resistant materials, e.g., various combination of Kevlar™ blast protection 230 at key extremities and bullet-proof glass 240 at key deflection surfaces around a standard steel cage 250 to deflect and withstand frontal 221 and side 222, 223 radar emissions and/or IED blasts.

Based on recent news reports, much of the IED casualties result from side blasts as a wheeled vehicle passes an IED blast zone. Recent news also reports of IEDs becoming increasingly sophisticated to be able to penetrate conventional armor or blast protection. However, the basic ability of an IED to penetrate armor is premised on the presumption that there exists a penetrable impact area. As exemplified in FIG. 3a, by contouring the blast protection surface 230, the vehicle skin 220 can be configured such that the enemy is denied a significant direct penetrable impact area. Specifically, by sloping the sides of a triangular vehicle 200 to have a contoured rise from the extremities of the front 221 and the sides 222 and 223 to the center compartment 250, the shape becomes like a cross between a flying saucer and a space shuttle, or resembling the shape of a stealth fighter plane.

In a non-regenerative electric drive mode, e.g., the combustion-engine generator being disabled, the vehicle is also expected to be stealthy by virtue of the vehicle being silent and/or IR emission-free. By having the frontal 221 and side 222, 223 dimensions contoured and sloping, analogous to a stealth fighter, Applicant also believes the skin configuration can also be evasive against fixed ground radar, even in a mass formation.

Although, in a pure electric-motor driven mode with the recharge capability disabled, the battery is expected to have a finite charge capability, during the time of the electric-motor only operation, the vehicle is expected to be silent and IR emission-free. Further, because the vehicle is expected to be capable of significant electric charge in its batter(ies) 140, this allows a vast array of electronics and/or active cabin 250 environmental protection against any of the nuclear, biological or chemical hazards.

All this means a stealthy, silent, near invisible vehicle that can sustain a strike operation in the dark, IR-emission free, for the duration of a hostile mission, with its on-board fuel supply intact throughout its mission, only to be expended upon exiting from a hot zone for combustion-engine electric generation.

The vehicle profile is angled to look triangular, and the outer skin is contoured to rise from the extremities of its front and its two sides to a center compartment. Accordingly, even if a vehicle 200 is hit by an IED from the front 221 or the sides, 222, 223, the blast would tend to be aerodynamically sheared, or deflected up or down, following the contour of the sloping 220 outer skin. The bullet proof windows 240 can also be angled to flow with the overall contour of the skin 220. Thereby, the cabin 250 can remain resilient and intact as aided by the contoured blast protection 230 itself. This is maximum protection with maximum maneuverability.

The rear 224 profile can be largely flat and vertical. A simpler flat rear surface can accommodate any configuration of hinged exit door(s), mechanical access and/or ventilation and air handling, e.g., air intake, combustion exhaust, radiator and/or A/C ventilation. The theory is that an IED would not explode from the rear as the vehicle passes a hostile area.

These and other obvious variations to the exemplary embodiments Applicant has disclosed are all within the scope of the Applicant's disclosure. The claims as follows describe the actual scope of Applicant's invention.

1. An all-wheel power train adaptable to a three-wheeled land vehicle, comprising:
three wheels suspended from a land vehicle chassis, the three wheels being configured to define a pseudo-triangular shape, the front wheel of the three wheels defining the apex of the pseudo-triangular shape; and
three electric motors, each of the electric motors drivingly coupled to the respective one of the three wheels, and each electric motor being nestled in a respective suspension arrangement, removed from the land vehicle chassis itself.

2. The all-wheel power train according to claim 1, wherein at least the front wheel of the three wheels can be steered.

3. A hybrid light electric vehicle having three wheels, comprising:
three wheels suspended from a land vehicle chassis, the three wheels being configured to define a pseudo-triangular shape, the front wheel of the three wheels defining the apex of the pseudo-triangular shape, the three wheels being under a respective suspension arrangement;
three electric motors, each of the electric motors drivingly coupled to the respective one of the three wheels, each electric motor being nestled in the respective suspension arrangement, removed from the land vehicle chassis itself;
at least one rechargeable battery;
a vehicle-mounted combustion-engine electric generator; and
hybrid control means.

4. The hybrid light electric vehicle according to claim 3, wherein at least a front wheel of the three wheels can be steered.

5. The hybrid light electric vehicle according to claim 3, wherein the at least one electric motor is an electrically driven motor suitable for a hybrid vehicle energized from the at least one rechargeable battery.

6. The hybrid light electric vehicle according to claim 3, wherein the at least battery can be either charged or recharged by or from a plurality of the following means: an external DC power source, an external AC power source, and an internal vehicle-mounted combustion-engine generator.

7. The hybrid light electric vehicle according to claim 6, wherein the vehicle can additionally be either charged or recharged by or from a vehicle mounted solar or thermal energy converter.

8. The hybrid light electric vehicle according to claim 3, wherein the combustion-engine electric generator is an electric generator based on a combustion engine chosen from the group comprising a gasoline engine, an ethanol engine, a diesel engine, and a bio-diesel engine.

9. A fighting military vehicle based on a hybrid light electric vehicle, comprising:
three wheels configured to define a pseudo-triangular shape, the front wheel of the three wheels defining the apex of the pseudo-triangular shape, each wheel having a wheel well, each wheel being driven by a respective electric motor which is integral with the wheel mechanism and hidden within a respective wheel well;
a center compartment configured within the pseudo-triangular shape; and
an outer skin of the vehicle contoured based on the pseudo-triangular shape defined by the three wheels, the pseudo-triangular shape being used to contour the outer skin as a sloping stealthy body skin, the outer skin being contoured to rise from the extremities of its front and its two sides towards the center.

10. The fighting military vehicle according to claim 9, wherein the fighting military vehicle is based on a hybrid light electric vehicle comprises:
a land vehicle chassis, the three wheels being suspended from the chassis;
at least one rechargeable battery;
a vehicle-mounted combustion-engine electric generator; and
hybrid control means.

11. The fighting military vehicle according to claim 10, wherein the combustion-engine electric generator is an electric generator based on a combustion engine chosen from the group comprising a gasoline engine, an ethanol engine, a diesel engine, and a bio-diesel engine.

12. The fighting military vehicle according to claim 9, wherein key frontal and side areas of the outer skin are visually angled and made of blast-resistant materials.

13. The fighting military vehicle according to claim 9, wherein the outer skin of the vehicle can include at least one of Kevlar™ blast protection at key extremities and bullet-proof glass at key deflection surfaces around the center compartment to deflect and withstand frontal and side radar emissions, small-arms fire and IED blasts.

14. The fighting military vehicle according to claim 9, wherein the outer skin is contoured in sufficient angles to deny a significant direct penetrable impact area from either the front or the sides.

15. The fighting military vehicle according to claim 9, wherein the vehicle profile is angled to look triangular.
